(19) United States
(12) Patent Application Publication
(10) Pub. No.: US 2005/0025462 A1
(43) Pub. Date: Feb. 3, 2005

(54) Method and apparatus for equipping personal digital product with functions of recording and displaying of the digital video/audio multi-media

(76) Inventors: Hao-Chieh Chang, Taipei (TW); Hung-Heng Hsu, Kaohsiung City (TW); Yi-Chu Wang, Ping-Tung (TW); Kun-Chou Chen, Taipei City (TW); Jui-Hsiang Yang, Taipei City (TW)

Correspondence Address: BIRCH STEWART KOLASCH & BIRCH, PO BOX 747, FALLS CHURCH, VA, 22040-0747, US

(21) Appl. No.: 10/629,564

(22) Filed: Jul. 30, 2003

(30) Foreign Application Priority Data
May 2, 2003 (TW) 92112142

(51) Int. Cl. H04N 5/91

(52) U.S. Cl. 386/96; 386/111

(57) ABSTRACT

The invention provides a method for equipping personal digital product with functions of recording and displaying the digital video/audio multi-media, comprising: providing a modulated interlacing video signal and an analog audio signal for de-modulation and de-interlacing of the interlacing video signal; at the same time processing digital transformation of the analog audio signal for digitalizing the analog audio signal to obtain a digital audio signal; then compressing the de-interlaced video signal and the digital audio signal to obtain a compressed de-interlaced video signal and a compressed digital audio signal; putting the compressed de-interlaced video signal and the compressed digital audio signal under synchronous process to obtain a synchronized compressed video signal and compressed audio signal; finally, outputting the synchronized compressed video signal and compressed audio signal to a processing unit of digital apparatus for selecting from recording or displaying the digital video/audio multi-media of synchronized compressed video signal and compressed audio signal.

### BACKGROUND OF THE PRESENT INVENTION

1. Field of the Invention

The invention relates to a method for personal digital products to process digital video/audio multi-media, and more particularly, to a method and apparatus for equipping personal digital products with functions of recording and displaying the digital video/audio multi-media.

2. Description of the Prior Art

At present, as information technology develops, products such as analog television, hi-fi equipment, and video recorder and displayer have been gradually replaced by digital products such as Personal Computer, Notebook, Personal Digital Assistant, Digital Video Camera, Digital Still Camera, and High Definition Television, which have become very common electric appliances in household.

The trend of digitalization has formed since digital information is easy to save, and the powerful function of compression also helps to enlarge the quantity of information transmittance. For example, an analog television channel can only transmit one program, but a digital television channel can transmit three or four or more programs. Besides, digital signals can be processed in many different ways. Therefore, the application of Multimedia has flourished, in which the video/audio transmitting and displaying system is the mainstream developed in the consumer market. So-called multimedia is media containing information such as words, diagrams, images, sounds, and animation, and the information is displayed by at least two kinds of media contents at the same time, which is why it is called multimedia information.

Moreover, there is another main reason for the application of digitalization. In the transmitting and processing process of analog signal, many noises will accumulate and cannot be eliminated, but digital signal can eliminate these noises and to keep the quality and clarity of the original signal, and therefore the quality of frame is perfect. Take analog telephone used several years ago for example, when the user calls to Taiwan from abroad, he will sound vague and unclear since there are too many noises and he has to yell loudly on the phone. At present since the signal of telephone has been digitalized, the user's voice sounds very clear as if he were just in the next door. Therefore, when industry of video signal turns from analog to digital, more and more video processing equipment has to be equipped with function of converting analog signal to digital signal.

Furthermore, there are two kinds of standard of analog television at present, Nation Television Systems Committee and Phase Alternation Line. Standard of NTSC is used in Japan or the US, according to which a frame is formed by 525 scanning lines or 525 scanning lines are called a frame, which means the frame is displayed repeatedly at the speed of 30 frames per second. Yet 525 scanning lines that forms a frame is not finished in only one scanning. The frame is displayed by scanning one line and then the line following the next line. In other words, after the first line is scanned, the third line is scanned rather than the second line, and then the fifth, seventh, to the 525^{th} line. Then the scanning process returns to the second line and repeats, in the following are the fourth, sixth, eighth, etc. Therefore the smooth and clear frame displayed is actually constituted by an odd number, an even number, and then an odd number, the formatting method of which is called “double-space scanning”.

Interlaced video signal is formed by two fields, each of the two fields containing odd lines or even lines of the image. In the process of image capture, camera will output odd lines of image on instant in time and output even lines of image after 16.7 milli-seconds. Between process of outputting odd lines and even lines of the image, a temporal shift will occur. For a still frame, a good one can be obtained with this method. But for a frame with motion, the image will become blurred since serration will occur on the edge of the image. Besides, since field of odd lines and field of even lines are formed by only half amount of scanning lines (262.5 lines), each field of odd lines and field of even lines only has half of the resolution the original image has. And each field of odd lines and field of even lines is displayed at the speed of 60 field per second. Such frame will not appear to have motion artifacts to man's eyes, but if the frame is enlarged, the scanning lines will appear thick and the frame will become blurred.

The disadvantages of “Interlacing scanning” described above can be eliminated by a technique called “progressive scan.” In progressive scan, the first, second, third, to the 525^{th} line are scanned in order and displayed at the speed of 60 frames per second. Therefore its scanning speed is twice the scanning speed of “Interlacing” and the frame is displayed on the monitor with 525 scanning lines, which makes the frame fine and clear, which being the best merit of “progressive scan.” Therefore, most of the developed video and audio equipment at present has used this method for scanning and displaying.

However, video signal of current NTSC system, so far, has been mainly using the method of “Interlacing.” Therefore, if a frame constituted by interlacing is displayed by a displaying system using progressive scan, such as a DVD film edited by interlacing being directly broadcasted and displayed on HDTV, only frame of odd lines and frame of even lines can be displayed and the resolution of image will be worse (since the resolution of which is only half of the resolution original image). To solve this problem, the technique of “De-interlace” should be used. In other words, to de-interlace is a method to convert interlacing to progressive scanning. For example, to convert Standard Definition TV to High Definition TV, the scanning lines are enhanced from 480i to 720p. The transformation of editing and enhancing is composed by two steps, de-interlacing and resampling. De-interlacing is the more complicated one in the two steps since the interlacing image of odd lines and of even lines are temporally shifted, and if the combination is unchangeable, misalignment of image will occur. The misalignment of image should be amended so that a progressive image that can satisfy the vision can be produced. When an aligned image is produced, it is then put under resampling process to be weaved into an image.

Although the technique of de-interlacing can solve the problem that interlacing system is displayed on progressive scan system with poor resolution, yet there is still another problem that cannot be neglected, which is that the image broadcasted is always in motion, and if this is neglected and the field of odd lines and field of even lines are still combined, thus we can only get clear image in the case of a still frame but blurred image and motion artifacts in the case of a frame with motion and thus high image quality cannot be displayed, like the problem formerly described. Therefore there are two basic algorithms to select from in the technique of de-interlacing process, non-motion compensated and motion-compensated.

1. Non-Motion Compensated De-Interlacing Algorithm

Two basic linear transformation techniques of on-motion compensated de-interlacing algorithm are called Weave and Bob, in which Weave is the simpler one.

To weave is two input fields overlaid or woven together to produce a progressive frame. Although the different image fields can be fully aligned in the process of a still image in this technique and a clear 5 de-interlaced image can be produced; yet, when an image with motion is processed, obvious serrations or feathering will occur since the image with motion will shift as time goes by, and therefore, when image of odd lines and image of even lines are woven into one frame, misalignment of image will occur since there is a temporal shift between image of odd lines and image of even lines. Therefore there will be serrations or feathering and thus produces a blurred frame. Situations such as obvious serrations or feathering are not accepted in the radio broadcasting or professional television broadcasting.

Besides, since Bob only accept one of the fields of input image (for example, image of even lines), and the other field (image of odd lines) is discarded, the vertical resolution of image will decrease from 720×486 to 720×243. The voids of the discarded lines are filled in by adjacent scanning lines in this image with only half of the resolution in order to regain the resolution of 720×486. The merit of this algorithm is that it can eliminate motion artifacts of image and has the smallest calculation demand. The disadvantage of it is that the vertical resolution of input image is still half of that of the original image after interpolating, which causes the detail resolution of progressive scan image to decrease.

2. Motion Compensated De-Interlacing Algorithm

The best de-interlacing method is motion compensation. This technique has been used in DTV editing transformation of developed SDTV and hi-fi. The motion compensated de-interlacing method comprising inter-field movement being measured and pixels of two temporal shift fields being shifted to a common point in one instant. Motion estimation is consulted for deciding the shifting amount of each pixel, and wherein identification and tracking of motion vector is from one field to another field. A typical block-matching procedure is put into practice and a typical block size ranges from 4×4 pixels to 8×8 pixels. These blocks are used since in one instant only these pixel blocks of relative size can be shifted to correct spatial location.

And in dynamic video compression technique, compressed method of MPEG is used in practice at present, MPEG being abbreviation of Motion Pictures Experts Group. The editing standards of which can be divided into three parts: Video, Audio, and System. As the demand increases, new generations of MPEG standards are developed, such as MPEG1, MPEG2, MPEG4, and MPEG7.

Generally speaking, in a continually broadcasted motion picture, there is high relevance between the former picture and the latter one, therefore in a series of original motion picture sequences, there is high spatial relevance and high temporal relevance between the former picture and the latter one. And video compression is processed by removing redundant information according to the relevance of these two kinds of information to achieve the purpose of compression. The method of removing spatially redundant information is usually processed, according to the characteristic of human vision, with spatial transformation (such as Discrete Cosine Transform or Wavelet Transform) and quantization to filter and remove the part of high frequency to achieve compression. As for removing temporally redundant information, principle of Motion Estimation is used to find out and remove temporally redundant information to achieve compression. And in the process of MPEG compression (or encoding), three different methods are used to compress each frame: Intra-frame, Bi-directional frame, and Predicted frame. Wherein the Intra-frame does not need to put its relation with other frames in consideration since a complete frame is saved; Predicted frame takes former Intra-frame as reference frame, wherein the redundant part of frame is not saved and only different part of frame is saved; the principle of Bi-directional frame is the same as that of Predicted frame, the only difference being that Bi-directional frame can take former Intra-frame or Predicted frame as reference and can also take latter Predicted frame as reference.

When the image is de-compressed ( when it is broadcasted ), it is processed in an order opposite to that of encoding, first decoding, then Inverse Quantization and Inverse DCT, converting signal of frequency domain to spatial signal to transform the signal back into data stream before compression, and these data streams are then integrated and sent to video reconstructed image buffer (or video image buffer), which restores received data to original frames.

As is described above, a high-quality de-interlaced motion image is to be achieved, very complicated image process must be processed and therefore much calculating resource would be used up. So when a personal computer or a notebook is used to broadcast high-quality digital video/audio multi-media image, the system of PC is usually designed to use simpler algorithm to process de-interlacing algorithm of interlacing image in order not to use up too much resource in the Central Processing Unit of PC and prevent PC from executing other functions. For example, only Bob algorithm is used to process the de-interlacing of motion image. In this way, although image of digital multi-media can be watched on PC, yet the quality of digital multi-media image cannot be greatly enhanced. Besides, the image after being put under de-interlacing process is compressed image restored, therefore the bandwidth of image will increase and cannot be output to monitor through output bus of PC and the de-interlaced image has to be sent directly to the monitor to be displayed. Therefore, the bandwidth of de-interlaced image has to be lowered to enable the de-interlaced image to be output from output bus of PC system to display de-interlaced image and record digital video program through PC system.

### SUMMARY OF THE PRESENT INVENTION

The problem described above is that digital video signal of high image quality cannot be processed and displayed by personal digital product, therefore the invention provides a method and hardware structure that can keep video signal of high image quality and decrease the demand on system resource of personal digital product, which can serve as a perfect solution for displaying multi-media video signal on advanced personal digital product in the future. Thus, digital video/audio multi-media can be displayed perfectly by PC system in high dpi, and some TV programs can also be saved in smaller space in hard disc of PC after being put under compressing and encoding process.

As is described above, the present invention provides a method for equipping personal digital products with functions of recording and displaying the digital video/audio multi-media, wherein through a system that processes digital video/audio multimedia, personal computer system is equipped with function of displaying digital multi-media of high image quality for effectively reducing calculating resource in personal computer system.

Another main purpose of the present invention is to provide a method for equipping personal digital products with functions of recording and displaying the digital video/audio multi-media, wherein through a system that processes digital video/audio multimedia, broadcasting programs and TV programs can be saved in smaller space in hard disk of PC after being put under compressing and encoding process to equip PC system with functions of pre-recording and broadcasting.

Still another main purpose of the present invention is to provide an apparatus for equipping personal digital products with functions of recording and displaying the digital video/audio multi-media, which combines different processing units into ASIC that can easily integrate with interface of PC system and effectively reduce complexity of design and cost of production.

According to the purposes described above, the present invention provides a method for equipping personal digital products with functions of recording and displaying the digital video/audio multi-media, comprising: first providing a modulated interlacing video signal and an analog audio signal for de-modulation and de-interlacing of the interlacing video signal to convert this interlacing video signal to a de-interlaced video signal; at the same time processing digital transformation of the analog audio signal to obtain a digital audio signal; then compressing the de-interlaced video signal and the digital audio signal to obtain a compressed de-interlaced video signal and a compressed digital audio signal; putting the compressed de-interlaced video signal and the compressed digital audio signal under synchronous process to obtain a synchronized compressed video signal and compressed audio signal; finally, outputting and displaying the synchronized compressed video signal and compressed audio signal.

The present invention also provides an apparatus for equipping personal digital products with functions of recording and displaying the digital video/audio multi-media, comprising: a digital video signal compressing unit that compresses a de-interlaced dynamic video signal to reduce bandwidth used by the de-interlaced dynamic video signal; a digital audio signal compressing unit that compresses a digital audio signal to reduce bandwidth used by the digital audio signal; a video/audio synchronizing unit that synchronizes the compressed de-interlaced video signal and the compressed digital audio signal to obtain synchronized compressed video signal and compressed audio signal and output the synchronized compressed video signal and compressed audio signal. Moreover, the apparatus can further include a digital video signal decoding unit, a de-interlacing unit, an audio signal analog/digital converting unit, and an outputting bus interface unit to output the synchronized compressed video signal and compressed audio signal for displaying or saving the synchronized compressed video signal and compressed audio signal.

### BRIEF DESCRIPTION OF THE DRAWINGS

FIG. 1 is the flow chart of the present invention.

FIG. 2 is a function block diagram of embodiment of the present invention.

FIG. 3 is a function block diagram of embodiment of the present invention.

FIG. 4 is a function block diagram of embodiment of the present invention.

### DETAIL DESCRIPTION OF THE PREFERRED EMBODIMENT

Since the related techniques and methods of Interlacing, De-Interlacing, and MEPG compressing standard have been described in detail in prior art; therefore the complete process of these techniques and methods is not included in the following description. Moreover, the art of encoding and decoding used in the present invention adapted from MPEG compressing technique is quoted in summary here to support the description of the invention. And the block diagrams in the following text are not made according to relative position in reality and complete connect diagram, the function of which is only to illustrate the features of the invention.

According to this, the present invention first provides a method for equipping personal digital products with functions of recording and displaying the digital video/audio multi-media, comprising: first providing a modulated interlacing video signal and an analog audio signal for de-modulation and de-interlacing of the interlacing video signal to convert this interlacing video signal to a de-interlaced video signal; at the same time processing digital transformation of the analog audio signal to obtain a digital audio signal; then compressing the de-interlaced video signal and the digital audio signal to obtain a compressed de-interlaced video signal and a compressed digital audio signal; putting the compressed de-interlaced video signal and the compressed digital audio signal under synchronous process to obtain a synchronized compressed video signal and compressed audio signal; finally, outputting and displaying the synchronized compressed video signal and compressed audio signal.

The present invention also provides an apparatus for equipping personal digital products with functions of recording and displaying the digital video/audio multi-media, comprising: a digital video signal compressing unit that compresses a de-interlaced dynamic video signal to reduce bandwidth used by the de-interlaced dynamic video signal; a digital audio signal compressing unit that compresses a digital audio signal to reduce bandwidth used by the digital audio signal; a video/audio synchronizing unit that synchronizes the compressed de-interlaced video signal and the compressed digital audio signal to obtain synchronized compressed video signal and compressed audio signal and output the synchronized compressed video signal and compressed audio signal. Moreover, the apparatus can further include a digital video signal decoding unit, a de-interlacing unit, an audio signal analog/digital converting unit, and an outputting bus interface unit to output the synchronized compressed video signal and compressed audio signal for displaying or saving the synchronized compressed video signal and compressed audio signal. And a processing unit in the personal digital product, equipped with the function of controlling recording and displaying of the synchronized compressed video signal and compressed audio signal.

The present invention then provides an apparatus for equipping PC with functions of recording and displaying the digital video/audio multi-media, comprising: a digital video signal decoding unit that puts a modulated interlacing video signal under de-modulating process to obtain a dynamic video signal; a de-interlacing process unit that puts the dynamic video signal under de-interlacing process to convert the interlacing video signal to a de-interlaced dynamic video signal; a audio signal analog/digital converting unit that puts an analog audio signal under digital conversion to obtain a digital audio signal; a digital video signal compressing unit that compresses the de-interlaced dynamic video signal to reduce the bandwidth used by the de-interlaced dynamic video signal; a digital audio signal compressing unit that compresses a digital audio signal to reduce bandwidth used by the digital audio signal; a video/audio synchronizing unit that synchronizes the compressed de-interlaced video signal and the compressed digital audio signal to obtain a synchronized compressed video signal and compressed audio signal; an outputting bus interface unit to output the synchronized compressed video signal and compressed audio signal for displaying the synchronized compressed video signal and compressed audio signal. And a CPU located in the personal digital product, equipped with the function of controlling the recording or displaying of the synchronized compressed video signal and compressed audio signal.

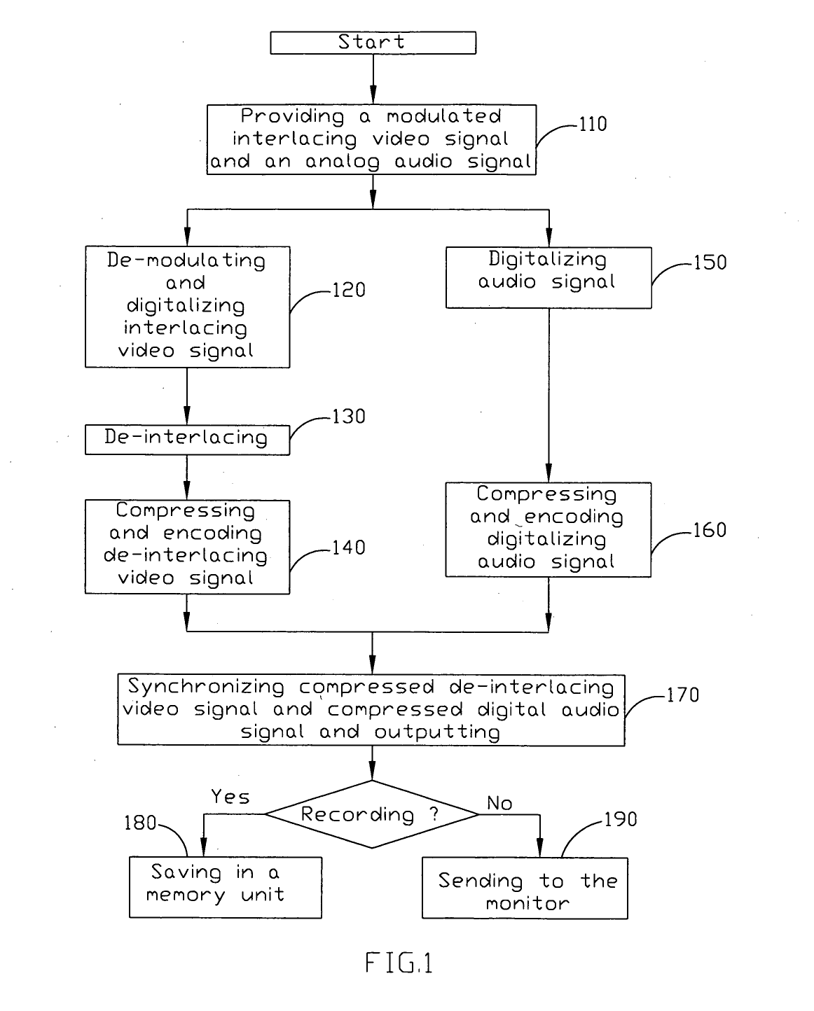

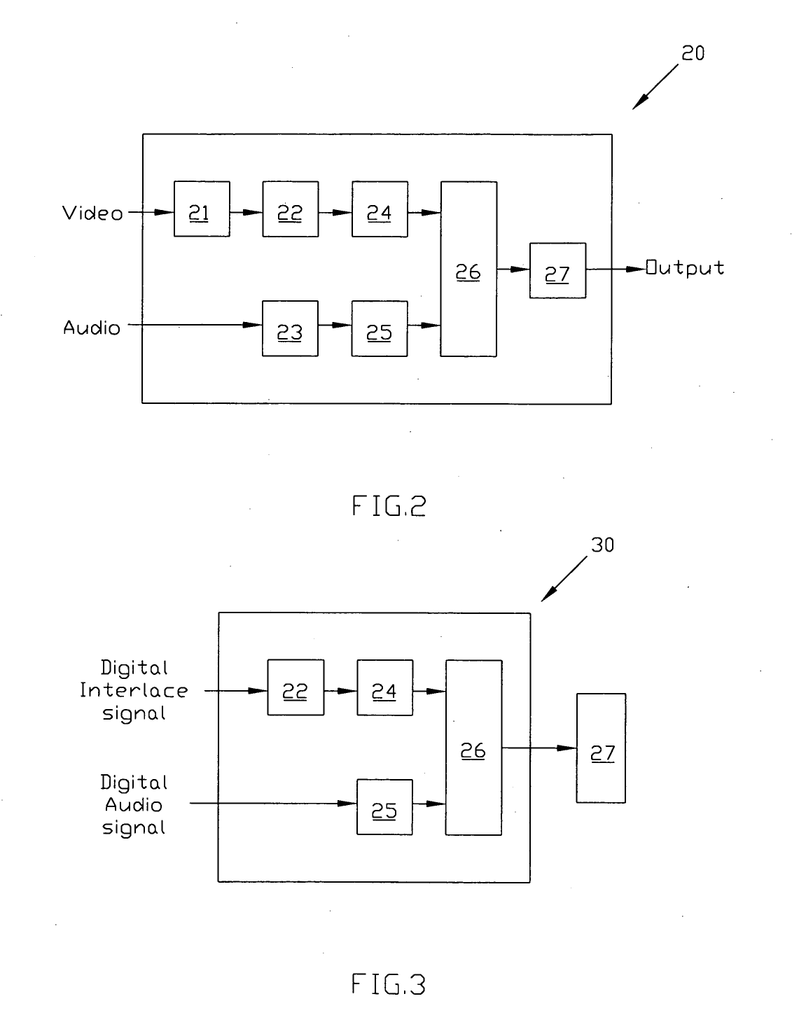

In the following is the detailed description of the invention, and please refer to FIG. 1 to FIG. 4, wherein FIG. 1 is a flow chart of embodiment of the invention, and FIG. 2 to FIG. 4 are function block diagrams of embodiment of the invention.

First, the method of the invention is illustrated by FIG. 1. As far as the broadcasting of multi-media at present is concerned, VCD/DVD player, CD-ROM player in PC, Cable TV Programs, and Broadcasting Programs can be used to broadcast, and the content of information broadcasted includes modulated interlacing video signal and analog audio signal. Therefore for a personal digital apparatus, its input terminal receives the modulated interlacing video signal and analog audio signal, as is shown in step 110. Then decoding of video signal of step 120 and digitalizing of audio signal of step 150 are processed simultaneously.

As for video signal, step 120 de-modulates the modulated interlacing video signal it receives to digitalize the input modulated interlacing video signal into a dynamic image edited by continuous interlacing field. Then, the decoded dynamic image is de-interlaced in step 130, using, for example, block matching algorithm, in which a series of de-interlacing process are processed in block-base to convert input interlacing image to de-interlaced image. And then, step 140 puts de-interlaced dynamic image under compressing and encoding process to reduce the bandwidth used by the dynamic image, in which the compressing and encoding methods such as MPEG series and several specifications of Motion Joint Photographic Experts Group can be used.

As for the received analog audio signal, it is digitalized in step 150 and the digitalized audio signal is compressed and encoded according to standard of audio in step 160. For example, specifications such as MPEG-1 Layer1, 2, 3, MPEG-2, AC3, or Adaptive Differential Pulse Code Modulation can be used. Since the ratio of compression of video signal and that of audio signal are different, the compressed video signal and audio signal have to be synchronized and multiplexed in step 170, the purpose of which is to put video signal and audio signal under multiplexing process of certain ratio according to the standard of compression and encoding to obtain a data stream of the synchronization image.

As for the compression standard of MPEG, its compression ratio of video signal must be higher than its compression ratio of audio signal, therefore the compressed video bits rate is divided by the compressed audio bits rate and the decimal of result is then carried unconditionally to obtain an integer. Then, the synchronizing and multiplexing process are processed according to this integral ratio to obtain a data stream of image of synchronized compressed video signal and compressed audio signal. Finally it is decided whether this synchronized data stream of image is sent to step 180 to be saved in a memory or directly sent to the monitor for displaying by step 190.

Then, PC system is taken as an example to describe the embodiment of the invention, and please refer to FIG. 2, in which a PC equipped with system 20 that records and displayed digital video/audio multi-media by the invention is displayed. System 20 receives modulated analog video signal or analog audio signal from communicating devices such as VCD/DVD player, CD-ROM player in PC, Cable TV Programs, and Broadcasting Programs, which are respectively processed by digital video signal decoding unit 21 and audio signal analog/digital converting unit 23. When digital video signal decoding unit 21 receives a modulated interlacing video signal, it demodulates the modulated video signal. When the modulated analog video signal is modulated and digitalized by the digital video signal decoding unit 21, an interlacing frame can be obtained. And then de-interlacing process of the frame is processed by de-interlacing unit 22 to convert the original frame composed by interlacing video signal to a progressive frame. A default method can be used for de-interlacing process. Weave Algorithm can be defaulted, and the method used for de-interlacing process can also be changed by external controlling interface (not displayed). Then, the progressive frame is compressed by digital video signal compressing unit 24. Compressing standard of MPEG2 is used, for example, for processing the compression of the progressive frame to obtain a compressed progressive frame, which is then sent to synchronizing and multiplexing unit 26 for the next step of process.

When the digital video signal is put under a series of de-interlacing and compressing process, system 20 provided by the invention will also send the analog audio signal it receives to audio signal analog/digital converting unit 23 for the process of digitalization of the audio signal to obtain a digital audio signal. The digital audio signal is then compressed by digital audio signal compressing unit 25 according to standard in proportion to that of compression of video signal, for example, audio signal compressing standard of MPEG2. The compressed digital audio signal is then sent to synchronizing and multiplexing unit 26 for the next step of process.

Since in current compressing standard, video signal and audio signal are compressed in different proportion, therefore compressed video signal and audio signal have to be synchronized and multiplexed before being sent to multi-media for broadcasting or saving. Thus when synchronizing and multiplexing unit 26 receives compressed video signal and audio signal from digital video signal compressing unit 24 and digital audio signal compressing unit 25 at the same time, it puts the compressed video signal and compressed audio signal under a multiplexing process of a ratio of equality according to a mixed proportion to obtain a synchronized compressed video signal and compressed audio signal. Finally, the synchronized compressed video signal and compressed audio signal are sent to bus interface processing unit 27 of PC to be transformed to universal specifications of speedy information transmittance so that they can be transmitted by the bus.

Peripheral Component Interconnect(PCI) or Universal Serial Bus(USB), for example, are used to display synchronized compressed video signal and compressed audio signal.

With the development of semi-conductor producing technique, the capacity of memory of unit square measure has increased. Therefore, the capacity of Hard-Disc used in PC currently has reached 500 hundred million byte (50 Giga Byte). As far as a multi-media film of high image quality is concerned, the dpi of each of its frames is at least 720×480 pixels. Thus, a multi-media film of 120 minutes needs at least 12 Giga Bytes to be saved in the memory, which is really large space for saving a film and is not very economical for the usage of memory capacity of Hard-Disk. Therefore, the main purpose of the system that equips personal digital product with functions of recording and displaying digital video/audio multi-media disclosed by the invention is to de-interlace the interlacing video signal transmitted by ordinary multi-media broadcasting system to transform frame of multi-media to progressive frame of high image quality. The progressive frame is then compressed so that a multi-media film needs only one tenth to one twentieth of the saving space it originally needs (about 650 Mega Byte ˜1.2 Giga Byte), which is very economical. If the user wants to record digital multi-media film broadcasted on Cable TV or TV program in advance and then watch it, the user can record the film by the system of the invention, which can save the film in the Hard-Disk. Besides, if the user wants to watch this digital multi-media film directly through VGA displaying interface, the film can be shown by directly sending de-interlaced progressive frame through bus interface unit to the monitor. Since the progressive frame is not processed by CPU of PC (not displayed), and its recording or broadcasting or recording and broadcasting simultaneously is only controlled by system interface of PC (not displayed), most of the resource of CPU will not be occupied. Therefore, the user can process affairs with his PC and record the program he wants to watch at the same time; while watching, the program recorded can be connected to HDTV for displaying through PC system, and PC can still carry out the work it is set to do. Thus, the user can enjoy the entertainment of multi-media and use calculating resource of PC for ordinary process at the same time without being burdened.

If the user can only use CD-ROM player in PC to play VCD/DVD film, since the CD-ROM player has already decoded the video signal and audio signal, thus the signal output includes digital interlacing video and audio signal. Therefore, an apparatus 30 to equip personal digital product with function of recording and displaying digital video/audio multi-media is disclosed in another embodiment of the invention, its composing elements comprising de-interlacing unit 22, digital video signal compressing unit 24, digital audio signal compressing unit 25, and synchronizing and multiplexing unit 26, referring to FIG. 3. The functions of each composing element in apparatus 30 of the invention and those of system 20 of the invention described above are the same and are not described repeatedly.

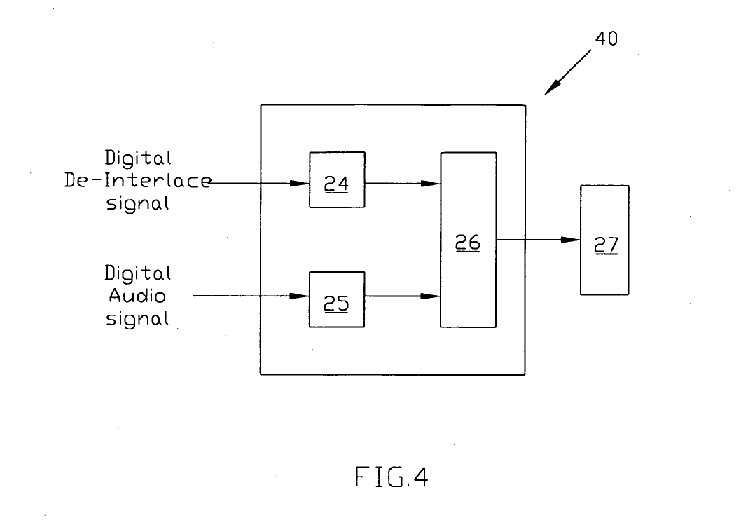

Besides, if the user uses advanced DVD player for playing, since the output video signal has been de-interlaced and the audio signal has also been digitalized, thus another apparatus 40 to equip personal digital product with function of recording and displaying digital video/audio multi-media is disclosed in still another embodiment of the invention, comprising digital video signal compressing unit 24, digital audio signal compressing unit 25, and synchronizing and multiplexing unit 26, referring to FIG. 4. The functions of each composing element in apparatus 40 of the invention and those of system 20 of the invention described above are the same and are not described repeatedly.

As the semi-conductor producing technique has progressed into process of 0.13 um, the techniques of Application Specific IC and System On a Chip also advance. Thus in each embodiment of the invention, the system that can equip personal digital product with function of recording and displaying digital video/audio multi-media provided by the invention can be integrated on a SoC chip; and since the composing elements of the apparatus that equips personal digital product with function of recording and displaying digital video/audio multi-media provided by the invention are digital signals, the function of the apparatus can be further achieved by ASIC.

What are described above are only preferred embodiments of the invention, not for confining the claims of the invention; and for those who are familiar with the present technical field, the description above can be understood and put into practice, therefore any equal-effect variations or modifications made within the spirit disclosed by the invention should be included in the appended claims.

1. A method for equipping personal digital product with functions of recording and displaying the digital video/audio multi-media, comprising:
providing a modulated interlacing video signal and an analog audio signal;
de-modulating and de-interlacing said modulated interlacing video signal to convert said modulated interlacing video signal to a digitalized de-interlaced video signal;
processing digital transformation of said analog audio signal for digitalizing said analog audio signal to obtain a digital audio signal;
compressing said de-interlaced video signal to obtain a compressed de-interlaced video signal;
compressing said de-interlaced audio signal to obtain a compressed de-interlaced audio signal;
synchronizing said compressed de-interlaced video signal and said compressed digital audio signal to obtain a synchronized compressed video signal and compressed audio signal; and
outputting said synchronized compressed video signal and compressed audio signal to a processing unit of said digital product for selecting from recording or displaying or both recording and displaying of said synchronized compressed video signal and compressed audio signal.

2. An apparatus for equipping PC with functions of recording and displaying the digital video/audio multi-media, comprising:
a digital video signal compressing unit, which compressing a de-interlaced dynamic video signal to reduce bandwidth used by said de-interlaced dynamic video signal;
a digital audio signal compressing unit, which compressing a digital audio signal to reduce bandwidth used by said digital audio signal; and
a video/audio synchronizing unit, which synchronizing said compressed de-interlaced video signal and said compressed digital audio signal to obtain synchronized compressed video signal and compressed audio signal and output said synchronized compressed video signal and compressed audio signal.

3. The apparatus according to claim 2, wherein said apparatus further includes a digital video signal decoding unit, said digital video signal decoding unit demodulating a modulated interlacing video signal to obtain a digitalized dynamic video signal.

4. The apparatus according to claim 2, wherein said apparatus further includes a de-interlacing unit, said de-interlacing unit de-interlacing a dynamic video signal to convert said interlacing video signal to a de-interlaced dynamic video signal.

5. The apparatus according to claim 2, wherein said apparatus further includes an audio signal analog/digital converting unit, said audio signal analog/digital converting unit putting an analog audio signal under digital transformation to obtain a digital audio signal.

6. The apparatus according to claim 2, wherein said apparatus further includes an outputting bus interface unit, said outputting bus interface unit outputting said synchronized compressed video signal and compressed audio signal for displaying said synchronized compressed video signal and compressed audio signal.

7. The apparatus according to claim 6, wherein said outputting bus interface unit is a USB.

8. The apparatus according to claim 6, wherein said outputting bus interface unit is a PCI.

9. A system for equipping personal digital product with functions of recording and displaying the digital video/audio multi-media, comprising:
a digital video signal decoding unit, which demodulating a modulated interlacing video signal to obtain a digitalized dynamic video signal;
a de-interlacing unit, which de-interlacing said dynamic video signal to convert said interlacing video signal to a de-interlaced dynamic video signal;
an audio signal analog/digital converting unit, which putting an analog audio signal under digital transformation to obtain a digital audio signal;
a digital video signal compressing unit, which compressing said de-interlaced dynamic video signal to reduce bandwidth used by said de-interlaced dynamic video signal;
a digital audio signal compressing unit, which compressing a digital audio signal to reduce bandwidth used by said digital audio signal;
a video/audio synchronizing unit, which synchronizing said compressed de-interlaced video signal and said compressed digital audio signal to obtain a synchronized compressed video signal and compressed audio signal;
an outputting bus interface unit, which outputting said synchronized compressed video signal and compressed audio signal for displaying said synchronized compressed video signal and compressed audio signal; and
a processing unit located in said personal digital product, which being used for controlling recording or displaying or both recording and displaying of said synchronized compressed video signal and audio signal.

10. The system according to claim 9, wherein said outputting bus interface unit is a USB.

11. The system according to claim 9, wherein said outputting bus interface unit is a PCI.

12. A system for equipping PC with functions of recording and displaying the digital video/audio multi-media, comprising:
a digital video signal decoding unit, which demodulating a modulated interlacing video signal to obtain a digitalized dynamic video signal;
a de-interlacing unit, which de-interlacing said dynamic video signal to convert said interlacing video signal to a de-interlaced dynamic video signal;
an audio signal analog/digital converting unit, which putting an analog audio signal under digital transformation to obtain a digital audio signal;
a digital video signal compressing unit, which compressing said de-interlaced dynamic video signal to reduce bandwidth used by said de-interlaced dynamic video signal;
a digital audio signal compressing unit, which compressing a digital audio signal to reduce bandwidth used by said digital audio signal; and
a video/audio synchronizing unit, which synchronizing said compressed de-interlaced video signal and said compressed digital audio signal to obtain a synchronized compressed video signal and compressed audio signal and to output said synchronized compressed video signal and compressed audio signal.

13. The system according to claim 12, wherein said system further includes a outputting bus interface unit, said outputting bus interface unit outputting said synchronized compressed video signal and compressed audio signal to display said synchronized compressed video signal and compressed audio signal.

14. The system according to claim 13, wherein said outputting bus interface unit is a USB.

15. The system according to claim 13, wherein said outputting bus interface unit is a PCI.
